(19) United States
(12) Patent Application Publication
(10) Pub. No.: US 2019/0042949 A1
(43) Pub. Date: Feb. 7, 2019

(54) METHODOLOGY FOR PORTING AN IDEAL SOFTWARE IMPLEMENTATION OF A NEURAL NETWORK TO A COMPUTE-IN-MEMORY CIRCUIT

(71) Applicant: Intel Corporation, Santa Clara, CA (US)

(72) Inventors: Ian A. YOUNG, Portland, OR (US); Ram KRISHNAMURTHY, Portland, OR (US); Sasikanth MANIPATRUNI, Portland, OR (US); Gregory K. CHEN, Portland, OR (US); Amrita MATHURIYA, Portland, OR (US); Abhishek SHARMA, Hillsboro, OR (US); Raghavan KUMAR, Hillsboro, OR (US); Phil KNAG, Hillsboro, OR (US); Huseyin Ekin SUMBUL, Portland, OR (US)

(21) Appl. No.: 16/147,143

(22) Filed: Sep. 28, 2018

(51) Int. Cl. G06N 3/10; G06F 17/50; G06N 3/063

(52) U.S. Cl. CPC G06N 3/10; G06N 3/063; G06F 17/5036

(57) ABSTRACT

A semiconductor chip is described. The semiconductor chip includes a compute-in-memory (CIM) circuit to implement a neural network in hardware. The semiconductor chip also includes at least one output that presents samples of voltages generated at a node of the CIM circuit in response to a range of neural network input values applied to the CIM circuit to optimize the CIM circuit for the neural network.

### FIELD OF INVENTION

The field of invention pertains generally to the computer sciences, and, more specifically, to a methodology for porting an ideal software implementation of a neural network to a compute-in-memory circuit.

### BACKGROUND

With the continually decreasing minimum feature size dimensions and corresponding continually increasing integration levels achieved by modern day semiconductor manufacturing processes, artificial intelligence has emerged as the next significant reachable application for semiconductor based computer processing. Attempting to realize semiconductor based artificial intelligence, however, creates motivations for new kinds of semiconductor processor chip designs.

### FIGURES

A better understanding of the present invention can be obtained from the following detailed description in conjunction with the following drawings, in which:

FIG. 1 shows a neural network;

FIGS. 2a through 2g show examples of different possible compute-in-memory unit cells;

FIGS. 3a and 3b show different hardware implementations of a CIM circuit;

FIG. 4 shows a read data line of a CIM circuit;

FIG. 5 shows a prior art memory circuit;

FIGS. 6a and 6b show ideal and non-ideal expressions that describe the behavior of an exemplary CIM circuit;

FIGS. 7a and 7b pertain to a methodology for porting a software implementation of a neural network to a compute-in-memory circuit;

FIGS. 8a and 8b show different system locations where a CIM circuit may reside;

FIG. 9 shows a computing system.

### DETAILED DESCRIPTION

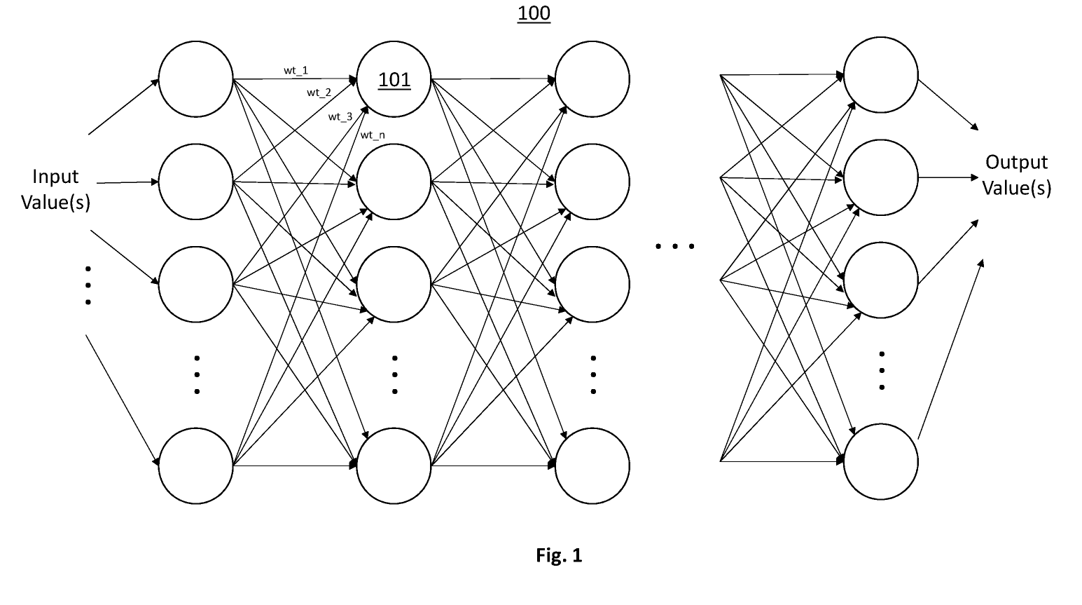

A neural network is the basic computational structure for Artificial Intelligence (AI) applications. FIG. 1 depicts an exemplary neural network 100. As observed in FIG. 1 the inner layers of a neural network can largely be viewed as layers of neurons that each receive weighted outputs from the neurons of other (e.g., preceding) layer(s) of neurons in a mesh-like interconnection structure between layers. The weight of the connection from the output of a particular preceding neuron to the input of another subsequent neuron is set according to the influence or effect that the preceding neuron is to have on the subsequent neuron (for ease of drawing only one neuron 101 and the weights of input connections are labeled). Here, the output value of the preceding neuron is multiplied by the weight of its connection to the subsequent neuron to determine the particular stimulus that the preceding neuron presents to the subsequent neuron.

A neuron's total input stimulus corresponds to the combined stimulation of all of its weighted input connections. According to various implementations, the combined stimulation is calculated as a multi-dimensional (e.g., vector) multiply accumulate operation. Here, output values from preceding neurons are multiplied by their respective weights to produce a set of products. The set of products are then accumulated (added) to generate the input stimulus to the receiving neuron. A (e.g., non-linear or linear) mathematical function is then performed using the stimulus as its input which represents the processing performed by the receiving neuron. That is, the output of the mathematical function corresponds to the output of the neuron which is subsequently multiplied by the respective weights of the neuron's output connections to its following neurons. The neurons of some extended neural-networks, referred to as “thresholding” neural networks, do not trigger execution of their mathematical function unless the neuron's total input stimulus exceeds some threshold. Although the particular exemplary neural network of FIG. 1 is a purely “feed forward” structure, other neural networks may exhibit some backwardization or feedback in their data flows.

Notably, generally, the more connections between neurons, the more neurons per layer and/or the more layers of neurons, the greater the intelligence the network is capable of achieving. As such, neural networks for actual, real-world artificial intelligence applications are generally characterized by large numbers of neurons and large numbers of connections between neurons. Extremely large numbers of calculations (not only for neuron output functions but also weighted connections) are therefore necessary in order to process information through a neural network.

Although a neural network can be completely implemented in software as program code instructions that are executed on one or more traditional general purpose central processing unit (CPU) or graphics processing unit (GPU) processing cores, the read/write activity between the CPU/GPU core(s) and system memory that is needed to perform all the calculations is extremely intensive. In short, the overhead and energy associated with repeatedly moving large amounts of read data from system memory, processing that data by the CPU/GPU cores and then writing resultants back to system memory, across the many millions or billions of computations needed to effect the neural network is far from optimal.

In order to dramatically improve upon this inefficiency, new hardware architectures are being proposed that dramatically reduce the computational overhead associated with implementing a neural network with a traditional CPU or GPU.

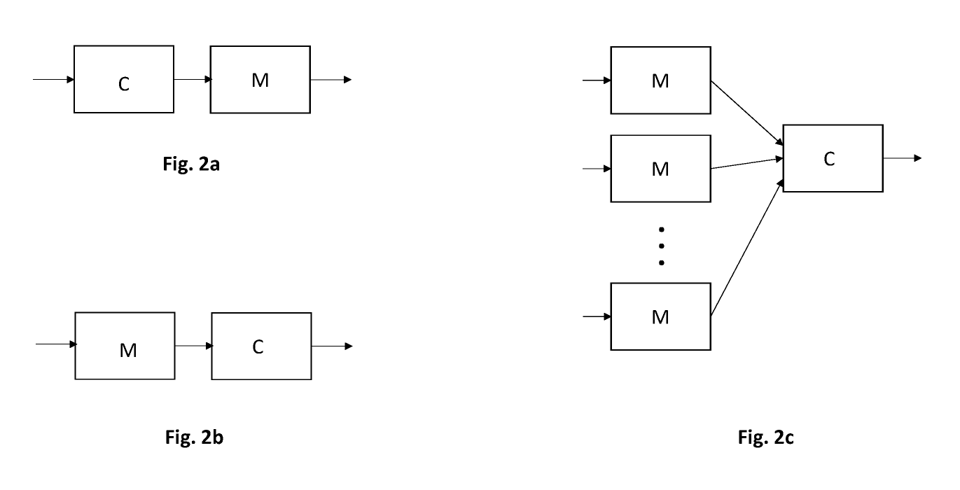

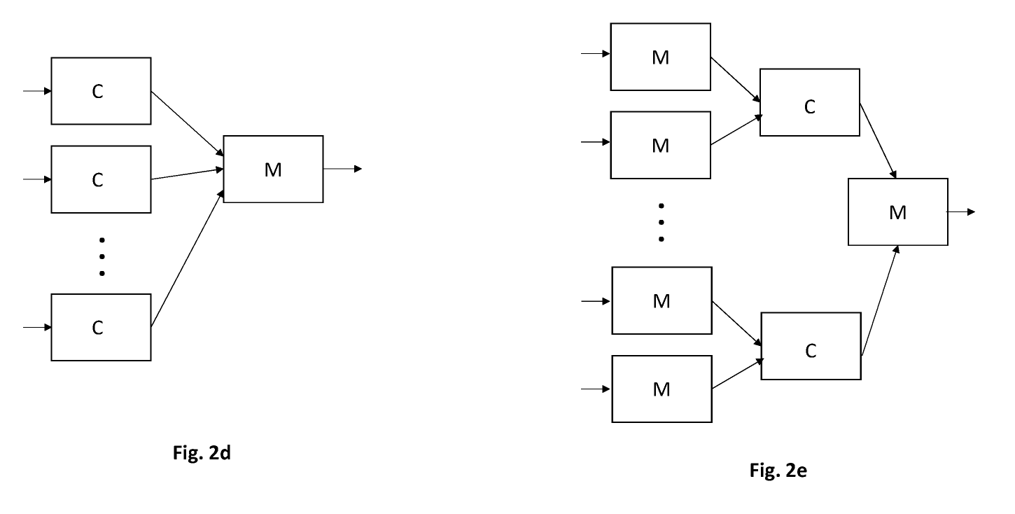

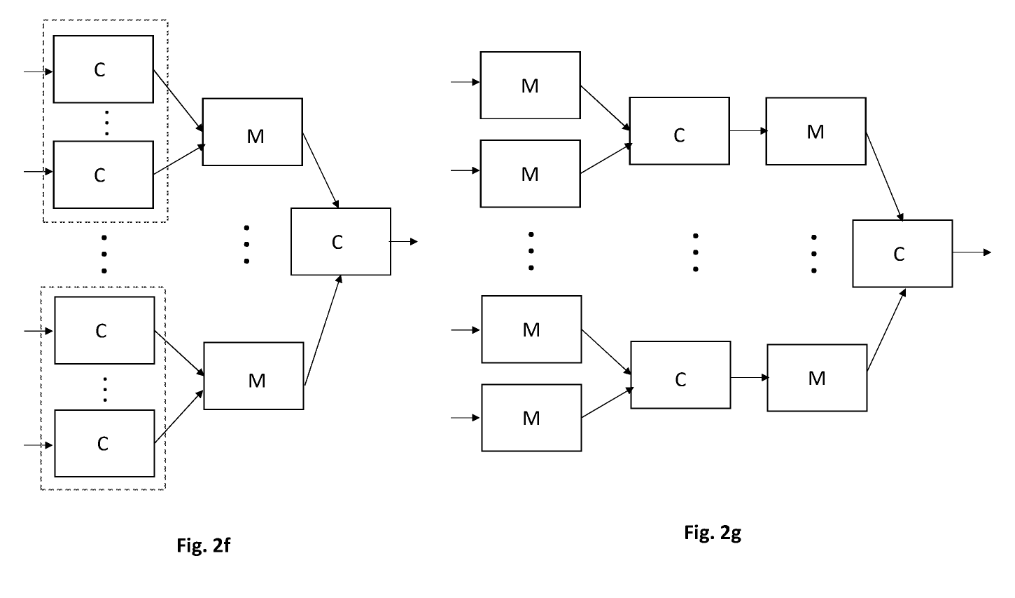

One such electronic circuit is a “compute-in-memory” (CIM) circuit that integrates mathematical computation circuits within a memory circuit (and/or integrates memory cells in an arrangement of mathematical computation circuits). FIGS. 2a through 2g show some possible, exemplary CIM unit cell blocks. Here, data that is stored in the memory cells (M) of a CIM circuit, which may correspond, e.g., to a connection weight, neuron output value, a product of a neuron output value and its corresponding weight, a neuron input stimulus, etc. is computed upon by mathematical computation circuitry (C) that physically resides near the memory cell where the data was stored. Likewise, data that is stored after being computed is generally stored in memory cell(s) that physically reside near the mathematical computation circuitry that calculated the data. The mathematical computation circuits may perform digital (binary logic) computations, linear/analog computations and/or some combination of the two (mixed signal computations). To the extent the CIM circuit computes both in digital and analog domains, the CIM circuit may also include analog-to-digital circuits and/or digital-to-analog circuits to convert between the two domains. For simplicity such circuits are not depicted in FIGS. 2a through 2g.

Here, for example, the mathematical computation circuitry that implements the mathematical function of a particular neuron may be physically located: i) near the memory cell(s) where its output value is stored; ii) near the memory cells where its output connection weights are stored; iii) near the memory cells where its input stimulus is stored; iv) near the memory cells where its preceding neurons' output values are stored; v) near the memory cells where its input connection weights are stored; vi) near the memory cells where the products of the neuron's preceding neurons' output values and their respective weights are stored; etc. Likewise, the input and/or output values to/from any particular connection may be stored in memory cells that are near the mathematical computation circuitry that multiplies the connection's weight by its input value.

By chaining or otherwise arranging large numbers of CIM unit cells (such as any one or more of the CIM unit cells of FIGS. 2a through 2g and/or variations of them) consistent with the discussion above in a pattern that effects a neural network an overall CIM neural network hardware circuit can be realized. Importantly, by keeping the memory cells that store data in close proximity to the circuits that generate and/or perform calculations on the data, e.g., in minimal distances achievable by a leading edge semiconductor logic and/or memory manufacturing process, the efficiency at which information can be processed through a CIM neural network is dramatically superior to an approach that implements a neural network entirely in software on a traditional computer system. Again, note that the unit cells of FIGS. 2a through 2g are only exemplary and CIM circuits having other structures are also possible.

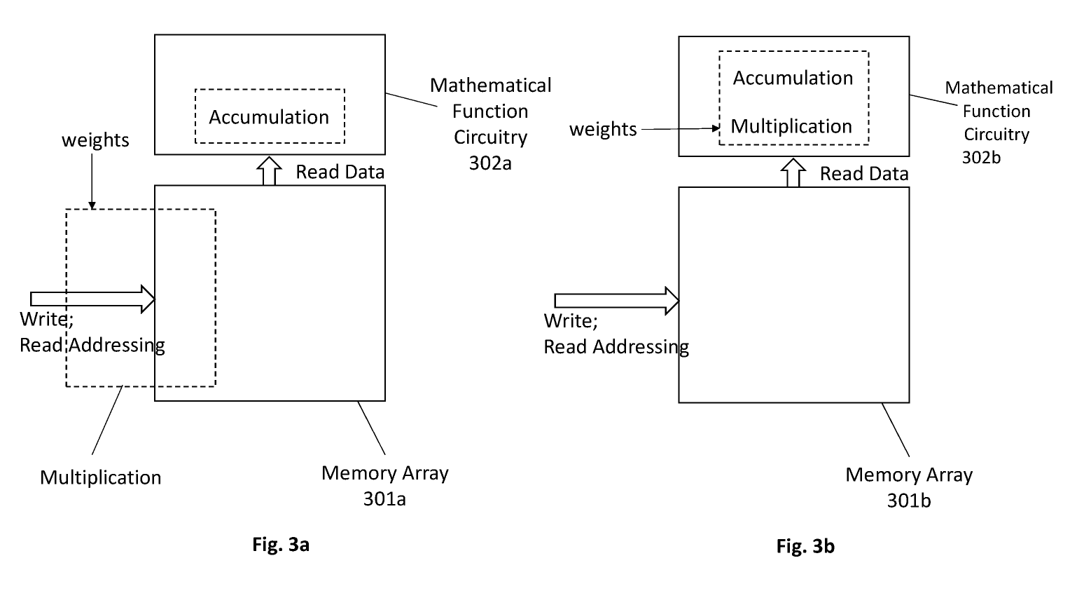

FIGS. 3a and 3b present two exemplary high level CIM circuit architectures. As observed in FIGS. 3a and 3b, both CIM circuits include a memory array 301 that is coupled to mathematical function circuitry 302. During a first phase values are written into the memory array 301. During a second phase values are read from the memory array 301 (commonly multiple values are read in parallel). During a third phase the mathematical function circuitry 302 performs computations on the values that were read from the memory array 301. Often, the mathematical circuitry 302 has one or more outputs that represent the output values of one or more neurons in the neural network.

Here, irrespective of whether the CIM circuit of FIG. 3a or 3b is purely binary, operates with more than two discrete levels or is a purely linear/analog circuit, and/or, irrespective of exactly what kinds of values are stored in the memory array 301 (e.g., just connection values, connection values and weights, products of connection values and weights, etc.), both the mathematical circuitry 302 and the precise interconnection structure between the memory array 301 and the mathematical circuitry 302 may be designed according to a number of different architectures.

Generally, however, the memory array 301 and mathematical circuitry 302 are designed to implement a (e.g., large scale) vector multiply accumulate operation in order to determine a neuron's input stimulus. Again, the multiplication of the connection values against their respective weights corresponds to the multiply operation and the summation of the resultant end-products corresponds to the accumulate operation.

According to the first architecture of FIG. 3a, the multiply operation is performed explicitly with multiplication circuitry that precedes the memory array 301a and/or is effectively performed by the manner in which the memory array 301a is accessed (e.g., during a memory read). The mathematical function circuitry 302a then determines the accumulated value (an accumulated value may be presented on a read data line that the mathematical function circuitry senses). In the architecture of FIG. 3a, a vector of weight values is processed by circuitry that precedes the memory array (e.g., a row decoder of the memory array).

By contrast, according to the architecture of FIG. 3b, the mathematical function circuitry 302b determines both the multiplication terms and the accumulation result. That is, the data that is read from the memory array 301b needs to be both multiplied and accumulated by the mathematical function circuitry 302b. As such, a vector of weight values is presented to and processed by the mathematical function circuitry.

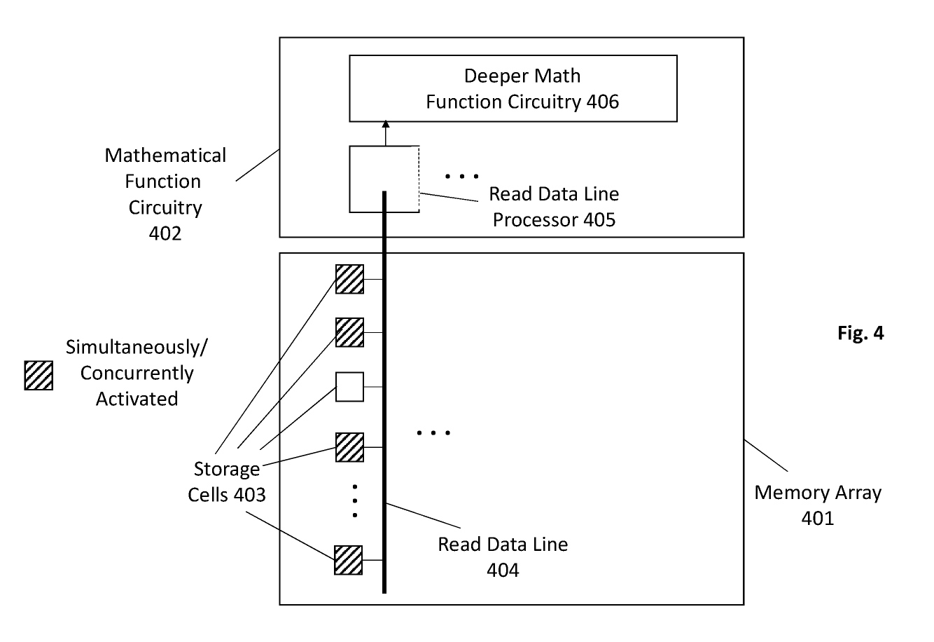

FIG. 4 shows another more detailed hardware design that can be utilized a CIM having the architecture of FIG. 3a or 3b. As observed in FIG. 4, the memory array 401 includes an array of memory cells 403, where, e.g., memory cells associated with a same memory dimension, such as an array column, are coupled to a same read data line 404. As is known in the art, in a traditional memory, memory cells that are coupled to a same read data line (such as memory cells along a same column that are coupled to a same bit line) can only be accessed one at a time. That is, e.g., only one row is activated during a read so that the data of only one cell is sensed on the bit line that is coupled to other cells along different rows.

By contrast, in the architecture of FIG. 4, multiple cells 403 that are coupled to a same read data line 404 can be simultaneously or at least concurrently activated during a same read operation so that the data stored by the multiple cells affects the voltage and/or current on the read data line 404 which, in turn, reflects some combined state of the cells' data. According to one application which can be used by the CIM architecture of either FIG. 3a or FIG. 3b, the CIM circuit utilizes more than two discrete voltage levels (e.g., four levels, eight levels, etc.) and the activation of multiple binary cells are combined on the same read data line 404 to establish one of these levels.

According to another application for use in the architecture of FIG. 3a, the combined state corresponds to an accumulation value. That is, the read data line 404 presents an accumulation value that is sensed by the mathematical function circuitry. As just one example, in CIM circuit that implements a purely digital neural network, connection values are either a 1 or a 0 and weights are either a 1 or a 0. During a multiply accumulate operation, the values of the different connections that feed into a same neuron are stored in the different memory cells 403 of a same column.

A vector of the weight values is then presented to the row decoder of the memory array 401 which only activates, for a read operation, those rows whose corresponding vector element has a weight of 1. The simultaneous/concurrent read of the multiple selected rows causes the read data line 404 to reach a value that reflects the accumulation of the values stored in the memory cells of only the selected rows. In essence, the selection of only the rows having a weight of 1 corresponds to a multiply operation and the simultaneous read of the selected rows onto the same read data line 404 corresponds to an accumulate operation. The accumulated value on the read data line 404 is then presented to the mathematical function circuitry 402 which, e.g., senses the accumulated value and then performs a subsequent math function such as a neuron math function.

As depicted in FIG. 4, read data line processing circuitry 405 is positioned toward the front end of the mathematical circuity 402 to sense read data line values. The read data line processing circuitry 405 may be partitioned in various ways. For example, there may be one instance of read data line processing circuitry per read data line, or, there may be one instance of read data line processing circuitry for multiple read data lines (e.g., to accumulate values across multiple read data lines). If the mathematical function circuitry 402 is to simultaneously process the math functions of multiple neurons the read data line processing circuitry 405 may also be partitioned such that read data line processing operations for different neurons are isolated from one another.

Read data line processing circuitry 405 is then coupled to deeper math function circuitry 406 which, e.g., performs neuron math functions. In various embodiments, the boundary between the read data line processing circuitry 405 and the deeper math circuitry 406 is crossed with an input stimulus value for a neuron. The deeper math function circuitry 406 may also be partitioned, e.g., along boundaries of different neurons and/or different math functions.

It is important to point out that the hardware architecture of FIG. 4 is just one example of many different hardware architectures that are possible according to the more general hardware architectures of FIGS. 3a and 3b.

With the advent of hardware based neural network computation circuits, existing neural network solutions (e.g., a specific neural network adapted for a specific artificial intelligence application) that have been implemented entirely as software programs executing on a CPU/GPU will, in many cases, be “ported” onto a CIM circuit instead. That is, an existing neural network having a specific set of connections, weights and neural math functions that is currently implemented as program code will have its connections, weights and math functions implemented instead into a CIM circuit.

A problem is that the software implementation is “absolute” in that its mathematical computations including both the large scale multiply accumulate operations that precede a neural math function as well as the neural math functions themselves are very precise. That is, by the nature of executing program code on a processor, the operands are explicitly precise (e.g., floating point calculations explicitly describe multiple significant digits in a single value) and the mathematical functions that operate on the operands generate high precision resultants (they have little/no associated error). Additionally, the precision of the operands and resultants are not affected by, e.g., tolerances/variances associated with the manufacturing process used to manufacture the processor or supply voltages and/or temperatures that are applied to the processor.

By contrast, a CIM circuit, such as a CIM circuit that is designed to interpret more than two memory read values on a single read data line, may have its operation change or drift in response to changes/variation in any of manufacturing related parameters, supply voltage and temperature. For example, if a multiplication function is performed with an amplifier, the gain of the amplifier may change in response to such changes/variation, which, in turn, results in different multiplication results for same input values.

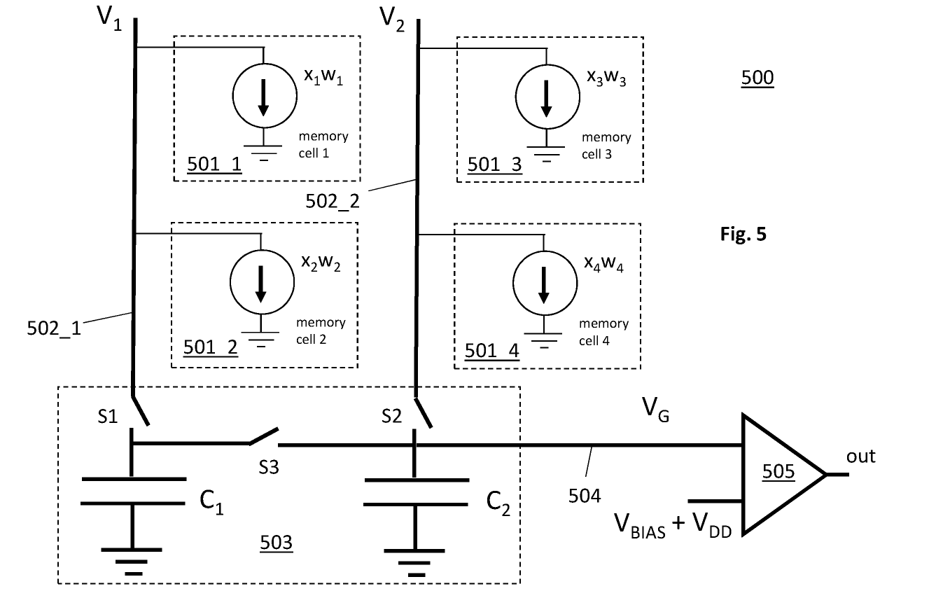

As such, the porting of a purely “ideal” software neural network into a CIM may necessitate “tweaking” of certain CIM circuit parameters and/or weights of the various connections between nodes of the neural network. FIG. 5 provides some insight into the kinds of variations and/or non-linearities that can exist in a CIM circuit. FIG. 5 shows a simplistic multiply-accumulate circuit 500 composed of two pairs of memory cells 501_1 through 501_4, where, each pair of memory cells is coupled to a respective read data line 502_1, 502_2. Here, any/all of the four memory cells may be activated and their data presented on the read data lines to, e.g., effect a vector multiply operation (that is, which specific memory cells are activated is a function of an applied vector of weights).

A switched capacitor circuit 503 is used to accumulate the charges on both read lines 502 to effectively perform the accumulate operation. For example, during a first clock cycle, switches S1 and S2 are closed and switch S3 is open to accumulate the charges from activated memory cells on a same read data line onto capacitors C1 and C2 respectively. Then, switches S1 and S2 are opened and switch S3 is closed to accumulate the charges from C1 and C2 onto node 504. The voltage V_{G} on node 504 that results from the combined charge of C1 and C2 corresponds to the accumulate resultant of the multiply-accumulate operation. The accumulate resultant is then presented to a comparator or thresholding circuit 505 that determines whether the accumulate resultant has exceeded a critical threshold (V_{BIAS}). Here, the particular CIM circuit 500 of FIG. 5 may be particularly useful in a thresholding type of neural network that was mentioned briefly above.

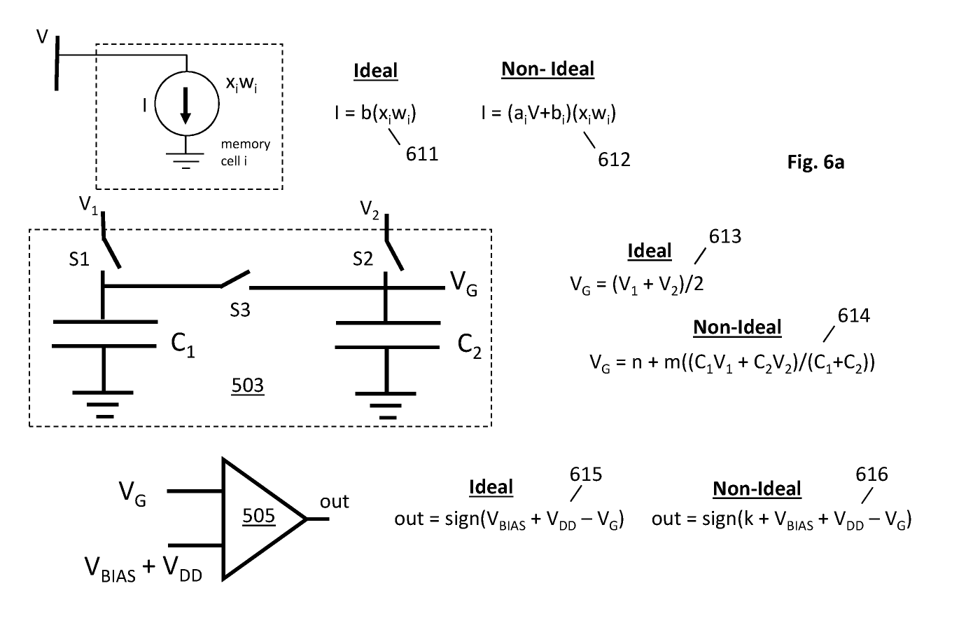

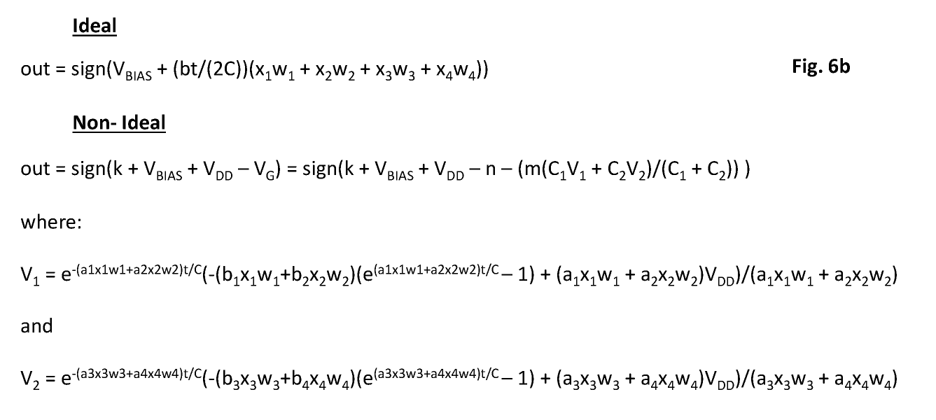

FIG. 6a compares ideal and non-ideal expressions for the different circuit elements (the read cells, the switched capacitor circuit and the thresholding circuit). As is understood by those of skill in the art, the non-ideal models represent a more accurate expression of circuit behavior than the ideal models.

Referring to FIG. 6a, the stored value in any particular memory cell is xᵢ and the weight that is to be applied to the stored value is wᵢ. Here, whereas the ideal memory read cell model 611 assumes constant transconductance across memory cells, by contrast, the non-ideal model 612 shows that memory cell transconductance is a linear function of the read data line voltage (V) and can vary from cell to cell. Here, the a and b terms are terms that include manufacturing related parameters and therefore may vary not only across different semiconductor die but also across different regions of a same semiconductor die.

Likewise, whereas the ideal expression for the switched capacitor circuit 613 assumes no variation in capacitance value (C1 and C2 always have equal capacitance), by contrast, the non-ideal expression for the switched capacitor circuit 614 makes no such assumption and includes separate C1 and C2 terms. Additionally, the non-ideal circuit model 614 correctly indicates that the actual voltage V_{G} that results from the switched capacitor's operation is a linear function of the voltage that theoretically should result when C1 and C2 are charged and coupled. Here, the linear function includes m and n terms that are largely determined by manufacturing related parameters.

Finally, whereas the ideal expression for the thresholding circuit 615 assumes that the comparison result is only a function of the two voltages to be compared (V_{G} and V_{BIAS}), by contrast, the non-ideal expression 616 indicates that an offset voltage k may be present in the circuit that causes the threshold decision to actually be triggered slightly above or slightly below the desired V_{BIAS} threshold level.

FIG. 6b compares ideal 621 and non-ideal 622 expressions for the entire circuit. Here, the ideal expression of the circuit 621 is derived from a combination of the ideal circuit models 611, 613, 615 of FIG. 6a, while, the non-ideal expression for the circuit 622 is derived from a combination of the non-ideal circuit models 612, 614, 616 of FIG. 6b.

Notably, even the ideal expression for the overall circuit 621 has terms that represent circuit variation as a function of time (t), applied voltage (V_{BIAS}) and manufacturing process parameters (b, C). The non-ideal expression for the circuit 622 depends upon an even greater set of manufacturing and/or environmental related terms that can vary (aᵢ, bᵢ, C1, C2, m, n, k) and therefore demonstrate additional circuit variation in response thereto. Even more elaborate models can incorporate temperature.

Thus, in summary, the ideal expression for the circuit 621 demonstrates that even if simplistic assumptions are made about the circuit's behavior, the circuit's behavior is still expected to vary as a function of manufacturing and environmental conditions. Accepting the non-ideal expression for the circuit 622 as the more appropriate expression to be emphasizing because it represents a more accurate expression of actual circuit behavior, it is clear from the non-ideal expression 622 that the circuit's behavior is an extremely complex function of manufacturing tolerances/variations and environmental conditions.

A first concern, therefore, is that the circuit's behavioral dependencies on manufacturing and/or environmental factors will result in different weight values being needed for a same neural network as between the “ideal” software implemented version of the neural network and the “imperfect” (variable in view of manufacturing tolerances and/or environmental conditions) CIM circuit implemented version of the neural network. Additionally, which specific weight values are appropriate for any particular CIM circuit implementation are apt to be different depending on manufacturing parameters and environmental conditions.

A second concern is that the complicated nature of the dependence of the circuit's behavior on manufacturing and environmental conditions (as is made clear from expression 622) makes it difficult to determine a correct set of weight values, given the specific set of manufacturing and environmental related conditions that actually apply to the specific CIM circuit that a neural network is to be ported to, from the weight values used in the ideal software implementation.

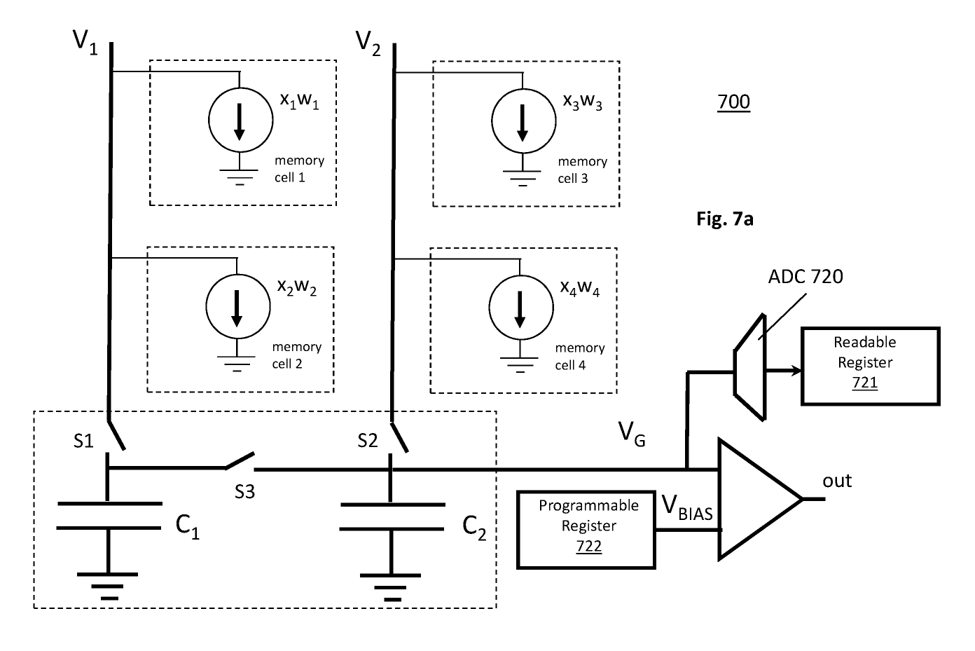

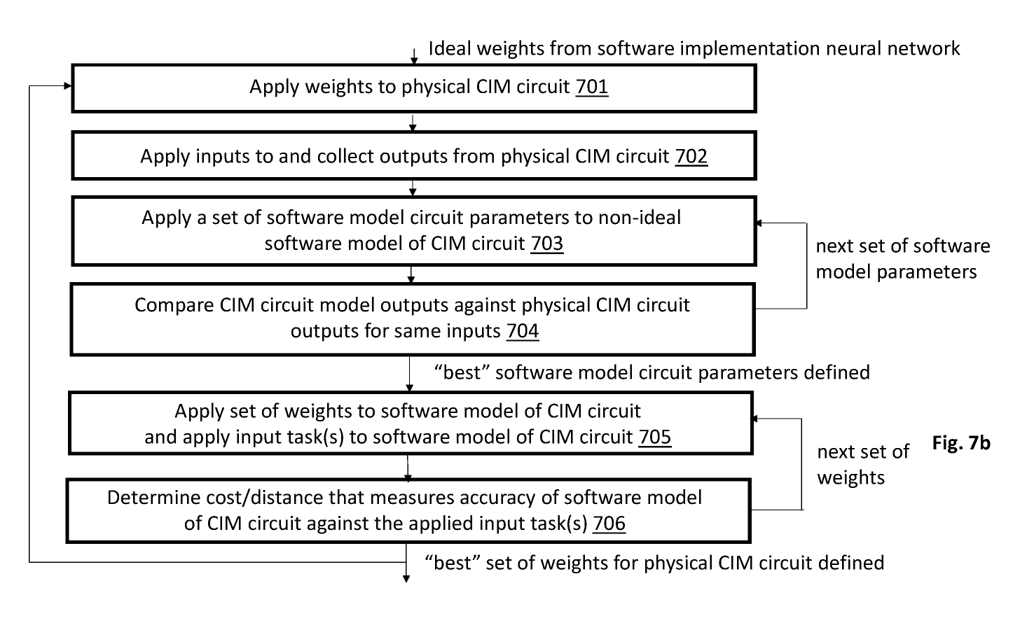

FIGS. 7a and 7b show a solution to the problem that uses an iterative mathematical optimization process 700 to “converge” to a correct set of weight values to be used with the CIM circuit. As observed in FIG. 7a, the CIM circuit 700 includes a design enhancement that provides for the actual voltage level that reflects the accumulated charge, V_{G}, to be physically monitored by way of an analog-to-digital (ADC) converter 720. Here, the ADC 720 samples the V_{G} value during a multiply-accumulate operation and writes the value into a readable register 721.

As described in more detail immediately below, multiple inputs are applied to the physical CIM circuit 700 and multiple V_{G} readouts are taken from register 721. From the set of inputs and sampled outputs, accurate values for aᵢ, bᵢ, C1, C2, m, n and k in the non-ideal model of the circuit (e.g., in FIG. 6b) are determined, and, ultimately, from the non-ideal software model of the CIM circuit having accurate values for aᵢ, bᵢ, C1, C2, m, n and k, a new set of weights for the physical CIM circuit are determined that should produce values that are the same as or are sufficiently similar to the values generated by the ideal software implementation of the neural network for same inputs.

As observed in FIG. 7b, initially, the weights used by the ideal software version of the neural network being ported are physically applied to the actual, physical CIM circuit 701. The physical CIM circuit is also configured to implement the specific math functions to be performed at the nodes of the particular neural network being ported. Thus, at this point, the CIM circuit is configured to execute the particular neural network.

Then, a series of inputs are applied to the CIM circuit (to effect a series of inputs applied to the neural network that the CIM is configured to implement) and the corresponding outputs, particularly, in the exemplary CIM circuit 700 of FIG. 7a, the sampled V_{G} values, are observed 702. Using the sets of input and output values, a series of software simulations of the CIM circuit, e.g., using the non-ideal model of FIG. 6b, are performed over a range of combinations of the model parameters aᵢ, bᵢ, C1, C2, m, n and k. For example, every possible combination of aᵢ, bᵢ, C1, C2, m, n and k are applied to the non-ideal software model of the CIM circuit, and, for each such combination, the set of input values that were applied to the physical CIM circuit are applied to the non-ideal software model of the circuit 703. The outputs generated by the non-ideal software model (e.g., for V_{G}) are then compared 704 with the physically observed output values (e.g., for V_{G}).

The process repeats until all possible combinations of values for aᵢ, bᵢ, C1, C2, m, n and k are attempted. After all possible combinations have been simulated 703 and evaluated 704, the particular combination of values for aᵢ, bᵢ, C1, C2, m, n and k that yielded the most accurate results (the non-ideal software model's outputs were closest to the physically observed ones) is chosen as the “best” set of parameters for the non-ideal software model.

In one approach, a stochastic gradient descent method is utilized to implement processes 703 and 704, e.g., in order to reduce the number of combinations of aᵢ, bᵢ, C1, C2, m, n and k that are actually simulated over. Here, an expression for the derivative of the non-ideal circuit model of FIG. 6b with respect to each of aᵢ, bᵢ, C1, C2, m, n and k (i.e., the gradient of the non-ideal circuit model expression of V_{B} with respect to its varying parameters) is used to determine a reduced set of combinations of parameters that will nevertheless flesh-out the circuit's behavior (e.g., first start with a large learning step size that gradually decreases over many iterations until convergence (the ideal final optimization point has a gradient of zero)).

Regardless, once the best combination of parameters is defined, they are incorporated into the non-ideal software model of the CIM circuit and different combinations of weights are iteratively applied to the non-ideal software model of the CIM circuit in a simulation environment. For each particular combination of weights that is applied to the non-ideal software model of the CIM circuit a set of input values are applied to the non-ideal software model of the CIM circuit 705. A cost/distance function that determines the accuracy of the non-ideal software model of the CIM circuit 705 is then computed 706.

For instance, if the neural network is used to identify different kinds of objects (e.g., different kinds of images for an image recognition system, different audio words or phrases for a voice recognition system, etc.), process 704 applies one or more input objects to the simulation model of the CIM circuit for the current set of weights being analyzed. Process 705 then computes a cost function (also referred to as a distance function) that determines how accurately the simulated model of the CIM circuit identified the object(s) it was tasked with identifying (e.g., a higher cost value reflects less accuracy whereas a lower cost value reflects greater accuracy). In essence, the non-ideal software model of the CIM circuit is tested in a software simulation environment to see how well it implements the neural network being ported 705, and, a cost/distance measurement that articulates the relative success/failure of the testing is determined 706. Conceivably a stochastic gradient descent method can be used to determine the weights (e.g., to apply less than all possible combinations of weights).

After the complete range of weights has been iterated through, the set of weights that generated the lowest cost are chosen as the best set of weights for implementing the neural network on the CIM circuit. If the cost of the non-ideal software model of the CIM circuit for the chosen weights corresponds to sufficiently accuracy for implementation of the overall neural network, the process is complete and the chosen weights are physically implemented into the actual CIM circuit. If the cost of the non-ideal software model of the CIM circuit for the chosen weights does not correspond to sufficient accuracy for implementation of the overall neural network, the entire process is repeated for a next iteration.

That is, the chosen weights are physically implemented within the actual circuit 701, the physical circuit with the newly chosen weights is evaluated 702 and a next best set of aᵢ, bᵢ, C1, C2, m, n and k parameters are iteratively determined 703, 704 for the non-ideal software model of the CIM circuit using the recently chosen weights as the weights for the simulation of the CIM circuit. After the next best set of aᵢ, bᵢ, C1, C2, m, n and k parameters are chosen, a next best set of weights for the CIM circuit are iteratively determined 705, 706 and so on.

Note that in alternative embodiments, processes 701 through 704 are treated as a separate optimization process and processes 705 and 706 are treated as a separate optimization process. In this case, a range of weights are physically applied to the physical circuit (e.g., according to a pre-determined criteria, a stochastic gradient descent method, etc.) and a set of circuit parameters that produces the most accurate CIM circuit model is ultimately converged to. Iterations over processes 705 and 706 to find a next best of weights may be triggered into action each time a new “best” set of circuit parameters is identified from a set of iterations over processes 701 through 704.

In further embodiments, referring back to FIG. 7a, note that a trimmable circuit parameter, such as a programmable V_{BIAS} setting 720, may be used to add an extra dimension over which iterations for circuit configurations may be performed. That is, the CIM circuit is modified to allow for manipulation of circuit behavior in a certain, pertinent location (the thresholding circuit). As such, the mathematical optimization process 700 of FIG. 7b can be extended to “tweak” the voltage that the thresholding circuit makes decisions against. In so doing, the mathematical optimization process should be able to generate a new set of weight values and appropriate CIM circuit configuration settings that causes the CIM circuit to generate same (or sufficiently same) output values as the ideal software neural network over the network's range of possible input values.

Here, for example, an additional iteration sequence can be inserted between sequence 703,704 and sequence 705, 706 to determine a best threshold value setting for the CIM circuit, or, e.g., the best threshold voltage configuration setting can be determined as part of iteration sequence 703, 704. Here, the characterization of the physical circuit at process 702 may also measure the comparator output as well as the V_{B} voltage to establish a set of comparator outputs for the set of applied inputs.

In the case where circuit parameters and configuration are determined separately, different threshold voltages are applied to the non-ideal software model of the CIM circuit in a simulation environment with the model incorporating the newly determined best set of parameters aᵢ, bᵢ, C1, C2, m, n and k. The simulated results are then compared against the comparator outputs that where observed during the characterization of the physical circuit 702. Each iteration involves a different threshold voltage, and, a best threshold voltage is ultimately chosen (the threshold voltage that caused the simulated model to generate results that were closest to the results generated by the physical circuit).

In the case where the circuit parameters and configuration are determined together, each iteration involves a specific set of aᵢ, bᵢ, C1, C2, m, n and k parameters and a threshold parameter. A stochastic gradient descent method can again be used to limit the number of combinations. Here, a gradient for not only for V_{B} but also comparator output is expressed with respect to aᵢ, bᵢ, C1, C2, m, n, k and threshold voltage.

It is pertinent to point out that the specific circuit 720 is only exemplary for the sake of discussion and that actual CIM circuits that make use of the teachings herein are apt to be designed to provide for more than one pertinent circuit parameter that can be adjusted. For example, if a following neural network node is to receive the V_{G} voltage (if the thresholding circuit indicates V_{G} has reached a high enough level) and multiply it against another value with an amplifier circuit, the CIM circuit may be designed to permit the gain of the amplifier circuit to be configurable so that, e.g., a range of gain settings for the amplifier can also be applied during process 703.

As such, various CIM circuits may have any of a number of pertinent circuits that are designed to a have a configurable parameter setting such as any of a programmable resistance setting, a programmable current setting, a programmable voltage setting, capacitance, etc.

Moreover, the discussions above should not be deemed to only be capable of teaching the specific circuit or specific non-ideal circuit model that were used above as examples. Certainly other CIM circuits, their non-ideal models and/or components within such circuits or models, and/or other non-ideal models of the CIM circuit that was discussed at length above are encompassed by the teachings of the present specification.

Additionally, for any CIM circuit, an approximation of its full SPICE (Simulation Program with Integrated Circuit Emphasis) model could also be used. For example, a polynomial of arbitrary order (linear, quadratric, cubic) can be fit to a spice model and use that for optimization. Furthermore, piecewise approximations with interpolation (interpolation methods: constant, linear, cubic, spline) can be implemented. For these models, it may or may not be possible to simplify/solve the expressions (often a system of differential equations) analytically, but as with SPICE, the equations can be solved numerically.

As such, the teachings herein are not limited solely to the set of circuit parameters discussed in the specific example of FIG. 7a (a manufacturing parameter, a coefficient for determining a current source's current, a capacitance, an offset voltage) but also embraces other circuits or circuit components not specifically mentioned as parameters in that particular example (e.g., a resistance, a inductance, an amplifier gain, an amplifier offset, coefficients of a piecewise model, coefficients of a polynomial model, coefficients of a SPICE model, etc.).

Further still, note that whereas the discussion above has been directed to the situation where the ideal software version of a network is being ported to CIM hardware version, it is altogether possible that the optimization process of FIG. 7b may need to be performed one or more times during the lifetime of the hardware implementation owing, e.g., to changes in environmental conditions or ageing of the underlying circuitry. For example, the optimization process may be triggered in response to any of a measured change in temperature, a measured change in supply voltage and/or a measured change in the performance of the circuitry owing, e.g., to ageing (e.g., transistor gain degradation, leakage current increase, etc.).

In various embodiments, the optimization process is executed by program code executing on, e.g., one or more CPU core(s) that are integrated on the same die as the CIM circuit. Adjustable circuit parameters may be tweaked by, e.g., the optimization software causing register and/or memory space that holds weight values and/or one or more CIM circuit parameter values to a specific value to be written to with desired weight values and/or circuit parameter values. Likewise, the CIM circuit may write its output values (e.g., the ADC output and/or comparator output in FIG. 7a) to register space or memory space so that the output values the CIM circuit generated for a neural network to be ported can be compared by the software program code against the output values generated by a corresponding ideal software implementation of the neural network.

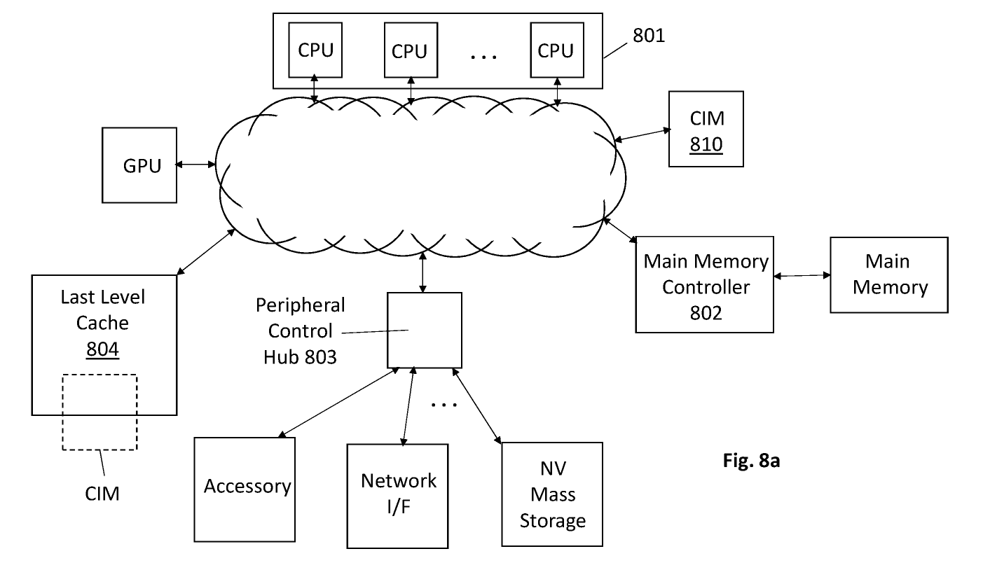

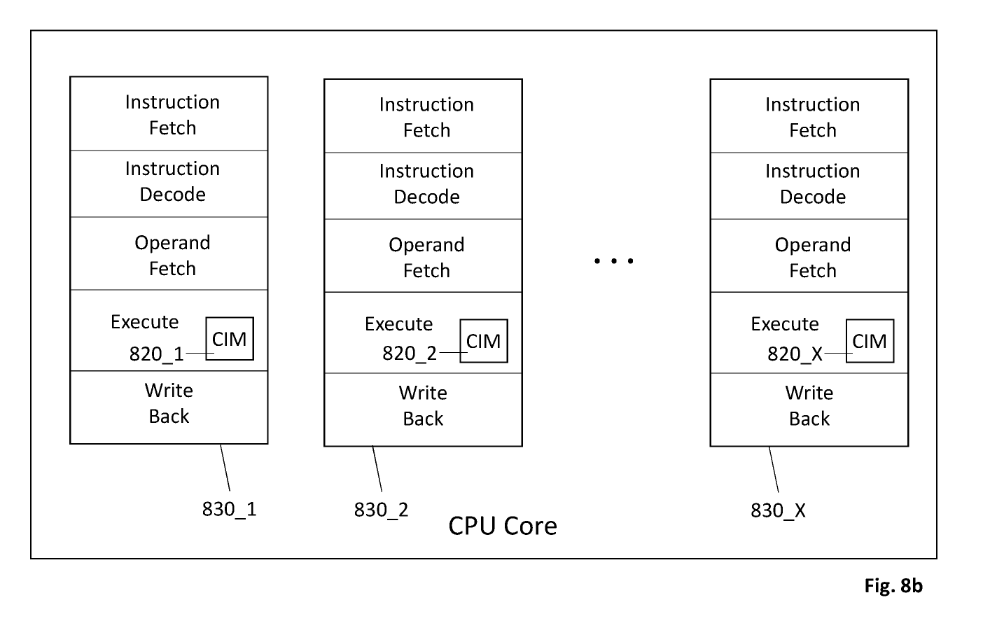

FIGS. 8a and 8b show different embodiments by which a CIM circuit for implementing a neural network in electronic circuitry, e.g., for artificial intelligence applications, as discussed above, may be integrated into a computing system. FIG. 8a shows a first approach in which a CIM circuit 810 is integrated as an accelerator or co-processor to the processor's general purpose CPU processing core(s) 801. Here, an application software program that is executing on one or more of the CPU cores 801 may invoke an artificial intelligence function.

The invocation of the artificial intelligence function may include, e.g., an invocation command that is sent from a CPU core that is executing a thread of the application and is directed to the CIM accelerator 810 (e.g., the invocation command may be supported by the CPU instruction set architecture (ISA)). The invocation command may also be preceded by or may be associated with the loading of configuration information into the CIM hardware 810.

Such configuration information may, e.g., define weights of inter-nodal connections and/or define math functions to be performed by the CIM accelerator's mathematical function circuits. With respect to the later, the CIM accelerator's mathematical function circuits may be capable of performing various math functions and which specific function is to be performed needs to be specially articulated/configured for various math circuits or various sets of math circuits within the CIM accelerator 810 (e.g., the math circuitry configuration may partially or wholly define each neuron's specific math function). The configuration information may be loaded from system main memory and/or non volatile mass storage.

The CIM hardware accelerator 810 may, e.g., have one or more levels of a neural network (or portion(s) thereof) designed into it's hardware. Thus, after configuration of the CIM accelerator 810, input values are applied to the configured CIM's neural network for processing. A resultant is ultimately presented and written back to register space and/or system memory where the executing thread that invoked the CIM accelerator 810 is informed of the completion of the CIM accelerator's neural network processing (e.g., by interrupt). If the number of neural network levels and/or neurons per level that are physically implemented in the CIM hardware accelerator 810 is less than the number of levels/neurons of the neural network to be processed, the processing through the neural network may be accomplished by repeatedly loading the CIM hardware 810 with next configuration information and iteratively processing through the CIM hardware 810 until all levels of the neural network have been processed.

In various embodiments, the CPU cores 810, main memory controller 802, peripheral control hub 803 and last level cache 804 are integrated on a processor semiconductor chip. The CIM hardware accelerator 810 may integrated on the same processor semiconductor chip or may be an off-chip accelerator. In the case of the later, the CIM hardware 810 may still be integrated within a same semiconductor chip package as the processor or disposed on a same interposer with the processor for mounting to, e.g., a larger system motherboard. Further still the accelerator 810 may be coupled to the processor over some kind of external connection interface (e.g., PCIe, a packet network (e.g., Ethernet), etc.). In various embodiments where the CIM accelerator 810 is integrated on the processor it may be tightly coupled with or integrated within the last level cache 804 so that, e.g., it can use at least some of the cache memory resources of the last level cache 804.

FIG. 8b shows an another embodiment in which a CIM execution unit 820 (also referred to as functional unit) is added to the execution units (or functional units) of the instruction execution pipeline(s) 830 of a general purpose CPU processing core. FIG. 8b depicts a single CPU core having multiple instruction execution pipelines 830 where each instruction execution pipeline is enhanced to include a CIM execution unit 820 for supporting neural network/artificial intelligence processing (for simplicity the traditional execution units used to support the traditional ISA are not shown). Here, the ISA of each instruction execution pipeline may be enhanced to support an instruction that invokes the CIM execution unit. The execution of the CIM instruction may be similar to the invocation of the CIM accelerator described just above with respect to FIG. 8b although on a smaller scale.

That is, for instance, the CIM execution unit may include hardware for only a portion of a neural network (e.g., only one or a few neural network levels and/or fewer neurons and/or weighted connection paths actually implemented in hardware). Nevertheless, the processing of multiple neurons and/or multiple weighted connections may be performed in a single instruction by a single execution unit. As such the CIM execution unit and/or the instruction that invokes it may be comparable to a vector or single instruction multiple data (SIMD) execution unit and/or instruction. Further still, if the single instruction and execution unit is able to implement different math functions along different lanes (e.g., simultaneous of execution of multiple neurons having different math functions), the instruction may even be more comparable to that of a multiple instruction (or multiple opcode) multiple data (MIMD) machine.

Connection weight and/or math function definition may be specified as input operand data of the instruction and reside in the register space associated with the pipeline that is executing the instruction. As such, the instruction format of the instruction may define not only multiple data values but possibly also, as alluded to above, not just one opcode but multiple opcodes. The resultant of the instruction may be written back to register space, e.g., in vector form.

Processing over a complete neural network may be accomplished by concurrently and/or sequentially executing a number of CIM execution unit instructions that each process over a different region of the neural network. In the case of sequential execution, a following CIM instruction may operate on the output resultant(s) of a preceding CIM instruction. In the case of simultaneous or at least some degree of concurrent execution, different regions of a same neural network may be concurrently processed in a same time period by different CIM execution units. For example, the neural network may be implemented as a multi-threaded application that spreads the neural network processing over multiple instruction execution pipelines to concurrently invoke the CIM hardware of the different pipelines to process over different regions of the neural network. Concurrent processing per pipeline may also be achieved by incorporating more than one CIM execution unit per pipeline.

Note that although the discussion of FIGS. 1 and 2 suggested that processing a neural network in a traditional CPU environment may be inefficient, introduction of a CIM execution unit as discussed above into one or more CPU cores may greatly alleviate such inefficiency because the CIM execution units are able to consume the information of a neural network at much greater efficiency than a traditional CPU could executing only traditional CPU instructions (e.g., less transfer of information between the CPU core(s) and system memory is effected).

Note that in various embodiments the CIM accelerator of FIG. 8a may be partially or wholly implemented as one or more instruction execution pipelines having one or more CIM execution units capable of executing a CIM instruction as described above with respect to FIG. 8b.

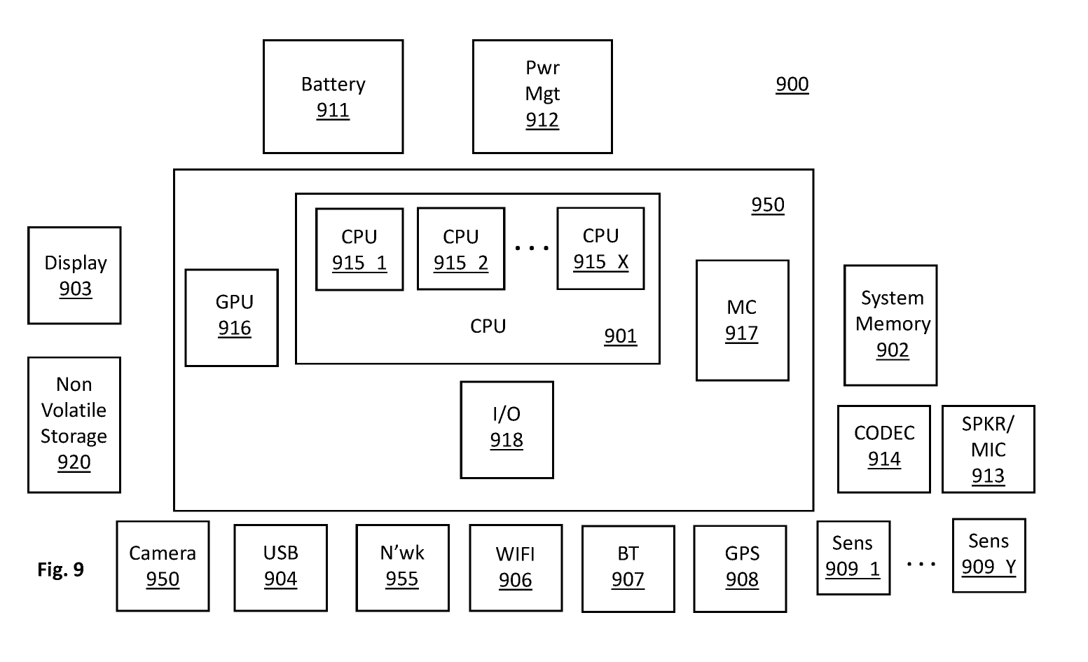

FIG. 9 provides an exemplary depiction of a computing system 900 (e.g., a smartphone, a tablet computer, a laptop computer, a desktop computer, a server computer, etc.). As observed in FIG. 9, the basic computing system 900 may include a central processing unit 901 (which may include, e.g., a plurality of general purpose processing cores 915_1 through 915_X) and a main memory controller 917 disposed on a multi-core processor or applications processor, system memory 902, a display 903 (e.g., touchscreen, flat-panel), a local wired point-to-point link (e.g., USB) interface 904, various network I/O functions 905 (such as an Ethernet interface and/or cellular modem subsystem), a wireless local area network (e.g., WiFi) interface 906, a wireless point-to-point link (e.g., Bluetooth) interface 907 and a Global Positioning System interface 908, various sensors 909_1 through 909_Y, one or more cameras 910, a battery 911, a power management control unit 912, a speaker and microphone 913 and an audio coder/decoder 914.

An applications processor or multi-core processor 950 may include one or more general purpose processing cores 915 within its CPU 901, one or more graphical processing units 916, a memory management function 917 (e.g., a memory controller) and an I/O control function 918. The general purpose processing cores 915 typically execute the operating system and application software of the computing system. The graphics processing unit 916 typically executes graphics intensive functions to, e.g., generate graphics information that is presented on the display 903. The memory control function 917 interfaces with the system memory 902 to write/read data to/from system memory 902. The power management control unit 912 generally controls the power consumption of the system 900.

Each of the touchscreen display 903, the communication interfaces 904-907, the GPS interface 908, the sensors 909, the camera(s) 910, and the speaker/microphone codec 913, 914 all can be viewed as various forms of I/O (input and/or output) relative to the overall computing system including, where appropriate, an integrated peripheral device as well (e.g., the one or more cameras 910). Depending on implementation, various ones of these I/O components may be integrated on the applications processor/multi-core processor 950 or may be located off the die or outside the package of the applications processor/multi-core processor 950. The computing system also includes non-volatile mass storage 920 which may be the mass storage component of the system which may be composed of one or more non volatile mass storage devices (e.g. hard disk drive, solid state drive, etc.).

The computing system may contain a CIM circuit having configurable circuit settings to support an optimization process for porting an ideal software implemented neural network into the CIM as described above.

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hard interconnected logic circuitry or programmable logic circuitry (e.g., field programmable gate array (FPGA), programmable logic device (PLD)) for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A machine readable storage medium containing program code that when processed by a processor causes a method to be performed, the method comprising:
applying a first range of values for a circuit parameter of a software model of a compute-in-memory (CIM) circuit and applying a first set of input values for a neural network to the software model of the CIM circuit for each of the values;
applying combinations of weight values for the neural network to the software model of the CIM circuit and applying a second set of input values for the neural network to the software model of the CIM circuit for each of the combinations, the software model of the CIM circuit including a selected one of the circuit parameter values;
repeatedly applying selected circuit parameter values and selected combinations of weight values to the software model of the CIM circuit with corresponding sets of input values for the neural network until output values generated by the software model of the CIM circuit in response are sufficiently within range of corresponding output values of the neural network.

2. The machine readable storage medium of claim 1 wherein the circuit parameter includes any of:
a manufacturing parameter;
a coefficient for determining a current source's current;
a capacitance;
an offset voltage;
a resistance;
an inductance;
an amplifier gain;
an amplifier offset;
coefficients of a piecewise model;
coefficients of a polynomial model;
coefficients of a SPICE model.

3. The machine readable storage medium of claim 1 wherein the applying a first range of values for a circuit parameter of a software model of a CIM circuit further comprises applying different combinations of values for more than one circuit parameter of the software model of the CIM circuit.

4. The machine readable storage medium of claim 1 wherein the method further comprises applying a third range of values for a configurable circuit parameter setting of the CIM circuit to the software model of the CIM circuit, selecting one of the configurable circuit parameter settings and configuring the CIM circuit with the selected one of the settings.

5. The machine readable storage medium of claim 1 wherein the method is performed to port the software implementation of the neural network to the CIM circuit.

6. The machine readable storage medium of claim 1 wherein the method is performed in response to a temperature change of the CIM circuit.

7. The machine readable storage medium of claim 1 wherein the method is performed in response to a voltage change of the CIM circuit.

8. A semiconductor chip, comprising:
a compute-in-memory (CIM) circuit to implement a neural network in hardware;
at least one output that presents samples of voltages generated at a node of the CIM circuit in response to a range of neural network input values applied to the CIM circuit to optimize the CIM circuit for the neural network.

9. The apparatus of claim 8 wherein further comprising an analog-to-digital converter coupled between the at least one output and the node.

10. The apparatus of claim 8 wherein the semiconductor chip further comprises a CPU processing core.

11. The apparatus of claim 10 wherein the CPU processing core is to execute program code that is to utilize the samples to optimize the CIM circuit for the neural network.

12. The apparatus of claim 11 wherein the utilization of the samples includes comparing output values of the CIM circuit against output values of the neural network.

13. The apparatus of claim 8 wherein the node is coupled to a read data line that is able to be concurrently driven by more than one activated memory cell.

14. The apparatus of claim 8 wherein the optimization of the CIM circuit for the neural network is to be performed in response to any of the following:
a decision to port said software implementation of said neural network to said CIM circuit;
a temperature change of said semiconductor die;
a voltage change of said semiconductor die.

15. A computing system, comprising:
a plurality of processing cores;
a system memory;
a memory controller between said system memory;
a mass storage device, said mass storage device comprising program code that when processed by a processor causes a method to be performed, the method comprising:
applying a first range of values for a circuit parameter of a software model of a compute-in-memory (CIM) circuit and applying a first set of input values for a neural network to the software model of the CIM circuit for each of the values;
applying combinations of weight values for the neural network to the software model of the CIM circuit and applying a second set of input values for the neural network to the software model of the CIM circuit for each of the combinations, the software model of the CIM circuit including a selected one of the circuit parameter values;
repeatedly applying selected circuit parameter values and selected combinations of weight values to the software model of the CIM circuit with corresponding sets of input values for the neural network until output values generated by the software model of the CIM circuit in response are sufficiently within range of corresponding output values of the neural network.

16. The computing system of claim 15 wherein the circuit parameter includes any of:
a manufacturing parameter;
a coefficient for determining a current source's current;
a capacitance;
an offset voltage;
a resistance;
an inductance;
an amplifier gain;
an amplifier offset;
coefficients of a piecewise model;
coefficients of a polynomial model;
coefficients of a SPICE model.

17. The computing system of claim 16 wherein the applying a first range of values for a circuit parameter of a software model of a CIM circuit further comprises applying different combinations of values for more than one circuit parameter of the software model of the CIM circuit.

18. The computing system of claim 15 wherein the method is performed to port a software implementation of the neural network to the CIM circuit.

19. The computing system of claim 15 wherein the method is performed in response to a temperature change of the CIM circuit.

20. The computing system of claim 15 wherein the method is performed in response to a voltage change of the CIM circuit.
